(19) United States
(12) Patent Application Publication
(10) Pub. No.: US 2016/0163483 A1
(43) Pub. Date: Jun. 9, 2016

(54) METHOD TO DETERMINE THE PRESSURE INSIDE OF A VACUUM INTERRUPTER, AND VACUUM INTERRUPTER ITSELF

(71) Applicant: ABB Technology AG, Zuerich (CH)

(72) Inventors: Dietmar Gentsch, Ratingen (DE); Kai Hencken, Loerrach (DE)

(21) Appl. No.: 15/005,017

(22) Filed: Jan. 25, 2016

Related U.S. Application Data
(63) Continuation of application No. PCT/EP2014/002038, filed on Jul. 25, 2014.

(30) Foreign Application Priority Data
Jul. 26, 2013 (EP) 13 003 743.5

(51) Int. Cl. H01H 33/668; G01L 21/34

(52) U.S. Cl. CPC H01H 33/668; G01L 21/34

(57) ABSTRACT

A method to determine pressure inside a vacuum interrupter for medium or high voltage use, having at least one fixed contact piece and at least one movable contact piece arranged inside the technical vacuum of a vacuum interrupter, and wherein contact pieces are electrically connected to external electrical fixation points can implement a high accuracy pressure sensing in rough conditions inside a vacuum interrupter, without additional components internally to the vacuum interrupter, by connecting the external electrical fixation points with an external electrical energy source, and in the disconnected or open position of the vacuum interrupter, the effect of a cold cathode vacuum gauge will be used, in that the leakage current between the open contacts generates an x-ray induced ionization of the rest-gas inside the vacuum interrupter, and the resulting current is measured with high resolution, in order to determine by this current the rest-gas pressure inside the vacuum interrupter.

### CROSS-REFERENCE TO RELATED APPLICATIONS

This application is a by-pass continuation of International Application No. PCT/EP2014/002038, filed Jul. 25, 2014, and claims benefit to European Patent Application No. 13 003 743.5, filed on Jul. 26, 2013, both of which are incorporated by reference herein. The International Application was published in English on Jan. 29, 2015, as WO 2015/010794 A1 under PCT Article 21(2).

### FIELD

The invention relates to a method to determine the pressure inside of a vacuum interrupter for medium or high voltage use, and a vacuum interrupter arrangement itself.

### BACKGROUND

Vacuum interrupters require a vacuum pressure below at least 10⁻¹ Pa in order to interrupt successfully a high current. Therefore the vacuum pressure needs to be guaranteed throughout their lifetime, which is typically more than 20 years. There have been some discussion regarding this in the recent years. The measurement of the residual gas pressure is a diagnostics method, which is increasing in importance in the future. On the one hand this is due to a relevant fraction of the installed base now reaching the end of guaranteed lifetime. In addition the vacuum interrupter technology is expected to be used in new areas, where a monitoring of the vacuum status is likely to be required.

Also pressure measurement means for vacuum are well known. But the implementation of pressure sensors inside vacuum interrupters is not easily applicable.

Common vacuum measurement equipment cannot be integrated easily within the closed VI bottle, also they often lead to a reduction of the reliability of the overall system. In addition the conditions within the bottle either during production or during operation (e.g. during the interruption of a short circuit) are rather destructive for known pressure sensors.

In addition vacuum interrupters which are already in operation are not equipped with any vacuum measurement sensors. Therefore the assessment of their vacuum status can only be done by using externally applied means.

A common method to investigate the vacuum status at the low pressures found after production (10̂-6 Pa) is currently the so-called “magnetron” or “inverse magnetron” principle. This is an application of a common cold-cathode pressure gauge measurement principle, but with the difference, that the bottle including the two electrodes and/or the shield is used as the measurement system. Whereas this system is used in a number of applications, especially during quality control in production, as well as in service, there are still difficulties in certain applications.

### SUMMARY

An aspect of the invention a method for determining a pressure inside of a vacuum interrupter for medium or high voltage use, the vacuum interrupter including a fixed contact piece and movable contact piece arranged inside a technical vacuum of the vacuum interrupter, and the contact pieces being electrically connected to external electrical fixation points, the method comprising: connecting the external electrical fixation points with an external electrical energy source, in which disconnected or closed position of, the vacuum interrupter will be used; applying a magnetic field element or magnetic field generating unit to thereby generate an approximate axial magnetic field, so that an effect of a cold cathode vacuum gauge will be used; initiating a current inside the vacuum interrupter by seed electrons generated from x-ray induced ionization of a material on a surface inside the vacuum interrupter, causing a resulting current of electrons and ions; and measuring the resulting current with high resolution, to determine by this current a residual gas pressure inside the vacuum interrupter.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an example of an application of the “magnetron principle”;

FIG. 2 shows an example of a first placement of the x-ray source;

FIG. 3 shows an example of a second placement of the x-ray source; and

FIG. 4 shows an example of an arrangement in which a magnetic field source is arranged close to a vacuum interrupter.

### DETAILED DESCRIPTION

An aspect of the invention relates to a method to determine the pressure inside of a vacuum interrupter for medium or high voltage use, and a vacuum interrupter arrangement itself, wherein at least one fixed contact piece and at least one movable contact piece are arranged inside the technical vacuum of a vacuum interrupter, wherein an axial and mostly homogenous magnetic field is applied in a way that it covers the relevant volume inside the vacuum interrupter and wherein the contact pieces are electrically connected to external electrical fixation points.

An aspect of the invention improves the highly accurate pressure sensoring based on the magnetron measurement approach inside a vacuum interrupter.

An aspect of the invention provides a current inside the vacuum interrupter is initiated by seed electrons generated from x-ray induced ionization of the material on the surface inside the vacuum interrupter causing a resulting current of electrons and ions, which is measured with high resolution, in order to determine by this current the residual gas pressure inside the vacuum interrupter.

For that, an external x-ray-source near to a vacuum interrupter is positioned in order to enhance the described effect of generating seed electron, in a predetermined way.

The main operation principle of the magnetron gauge can be described in the following way: The combined effect of the magnetic and electric field is to form a “trap”, which has the possibility to capture the electrons for a very long time, avoiding any loss due to collisions with some boundary. Due to this long path inside the bottle by some “circulating paths”, the distance traveled becomes comparable to the mean-free path in the residual gas. This means that after some time, the electrons will eventually collide with an atom from the residual gas. In such an ionization collision the electron will generate an additional electron and an ion. While the ion will be collected by the cathode, the new electrons will also be captured in the trap until it is eventually removed from it by further collision. In this way a measurable current generated from the interaction with the residual gas is generated. From this description it is obvious that the current will be related to the number of ionization collisions and therefore to the density (pressure) of the residual gas.

So in consequence, the rest-gas collisions and the resulting further electron emission can be quantitatively used for determining the rest gas pressure.

The only requirement for using the vacuum interrupter as a cold cathode vacuum gauge is, to have means for applying an axial magnetic field inside the vacuum interrupter and the possibility to apply a high voltate (typically between 1-10 kV) to either two contacts or to a contact and a shield and means for determining very small current signals, for registration of this effect. But the important benefit out of that is, that the pressure inside a vacuum interrupter can be determined very easy.

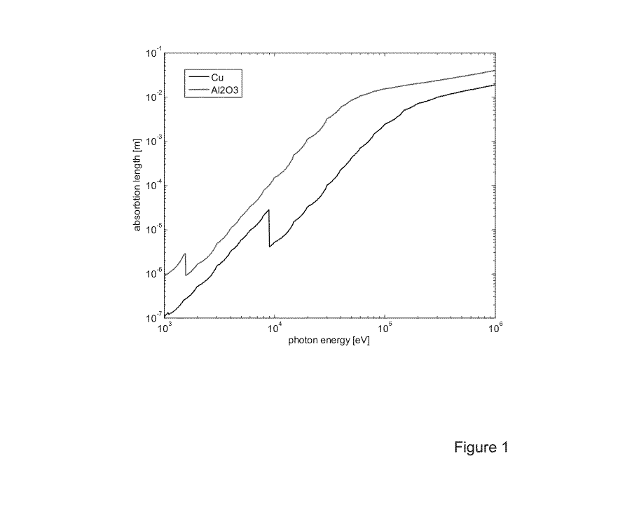

Already a number of techniques have been proposed for pressure measuring. The most often used one is the “magnetron principle” like described above. This method requires the application of an external axial magnetic field and a high voltage either between the two contacts or between the contacts and the shield. It also requires the initiation of the magnetron current. This can be done either by seed electrons produced by cosmic radiation or being provided by an initial field emission current. The basic principle is shown in the FIG. 1.

In order for this magnetron discharge to start, an initial “seed electron” is needed, which then leads to an avalanche of additional ionization processes until a macroscopic current is flowing through the vacuum interrupter. The initiation of the magnetron current by a seed electron is often difficult to achieve, especially at low pressures. Even commercial magnetron gauges, so-called cold-cathode magnetron gauges, often need seconds to minutes to start up. As they are build as traps, that is, the electrons are kept confined, the current remains continuously flowing after this initiation stage. This can similarly be used in the magnetron measurement principles for vacuum interrupters. Here one doesn't have a “perfect trap” configuration of the electric field, but still some electrons are kept within the vacuum volume. Therefore a magnetron-like measurement in vacuum interrupters typically produces more complex current patterns. In addition the vacuum interrupter is a restricted vacuum volume. The discharge itself will lead to a cleaning or “pumping” of the residual gas. That is the residual gas is removed by the discharge. Therefore the current distribution is not constant but often with a short pulse at the beginning and a smaller continuous current afterwards. The maximum of this current pulse is typically used as the measured current.

Due to the random production of the initial seed electron the starting time to initiate this current is statistical distributed. This leads to uncertainties in the vacuum measurement or doesn't allow the application of the measurement principle at all.

In order to reduce the startup time often a very large (˜10 kV) high voltage is applied. This has the effect, that seed electrons are generated from field emission from one of the electrodes or the shield, which then serves as a cathode. A disadvantage of this method is, that the large voltage cannot be chosen according to the optimal operation of the magnetron, for example, in order to reduce the pumping effect.

The invention therefore solves the problem of initiation of the magnetron current by producing seed electrons in the vacuum interrupter interior using an x-ray radiation source.

The low particle density of the residual gas in the vacuum interrupter under normal operational conditions doesn't allow for an ionization process to take place directly in its interior vacuum volume.

But one has to keep in mind, that a large amount of electrons is produced inside the solid material surrounding the vacuum volume. Most of these electrons are absorbed by this material, but electrons that are produced close to the surface have a probability to escape the solid material and enter the vacuum volume. These are then the seed electrons, we are looking for.

So important for that invention is, that the leakage current is not initiated by sheer chance for example by environmental radiation, but in a reproductive way, using a determined x-ray source, in order to use the effect in a reproductive and precise way.

The basic effect for the use in the invention is as follows

At energies above a few 10^{th} of kV x-ray radiation is absorbed to a lesser degree by material, as this energy is above the K-line for most light and medium heavy elements. Therefore a x-ray photon with this energy has a significant probability to cross the solid material outside the vacuum interrupters, that is either the ceramics and or the shield of a “naked” vacuum interrupters or even the material of the pole in the case of an embedded vacuum interrupter (most often either epoxy or thermoplastics). The absorption lengths of Cu and Al2O3 as typical materials found in the vacuum interrupter bottle design, are shown below. For example a 100 kV x-ray has an absorption length of more than 1 mm for Cu and more than 1 cm for aluminum oxide. See FIG. 1.

The x-ray radiation will produce electrons throughout the solid material. Seed electrons will be produced by those x-ray photons, that release electrons in a small range close to the surface of any material. Typically values are that electrons produced within a few 10^{th} of nm have a significant probability to be released. This depends strongly on the electron energy, given here for electrons in the keV range, which are the most relevant ones for the purpose of initiating the magnetron discharge.

If the x-ray energy is too large, the absorption length will be larger than the material in question. Under these conditions the number of electrons produced will be low. It can be shown, that under rather general circumstances the optimal x-ray energy is the one, where the absorption length is about the same as the material thickness. This gives us an energy range above 40 keV and below 1 MeV to be best suited for our application.

Based on these number, we can make a rough estimate about the number of seed electrons produced per initial photon. Assuming an electron yield of one per initial photon, one estimates that roughly one electron is produced for about 1 million initial photons. Therefore the strength of the x-ray radiation needs to be strong enough to produce at least several millions of x-ray photons.

There exists nowadays x-ray sources, that produce the x-ray radiation as short pulses, below 100 nm. These are mostly used for material inspection. The pulsed sources are an advantage for our application, as the dose can be very high for only a short time, which is then used to start the magnetron discharge of the vacuum interrupter at a prescribed time, but does not influence it afterwards. Alternatively one could use a continuous source in order to reduce (only) the time needed to start the discharge, which allows for a lower dose but with the disadvantage of having no control over the starting time per se.

As the seed electrons are now produced not by the field emission and therefore independently of the level of the high voltage applied, one can select voltage level applied to the vacuum interrupter based on the suitable discharge currents and does not need to select a high enough value to release enough field emission current, which is a problem with some geometries.

By applying in addition an axial magnetic field and a high voltage to either the contact and the shield or to the two contacts, a magnetron discharge is produced and the current shape is measured. Some values of this current, especially the maximum, is measured and used to infer the vacuum inside the VI.

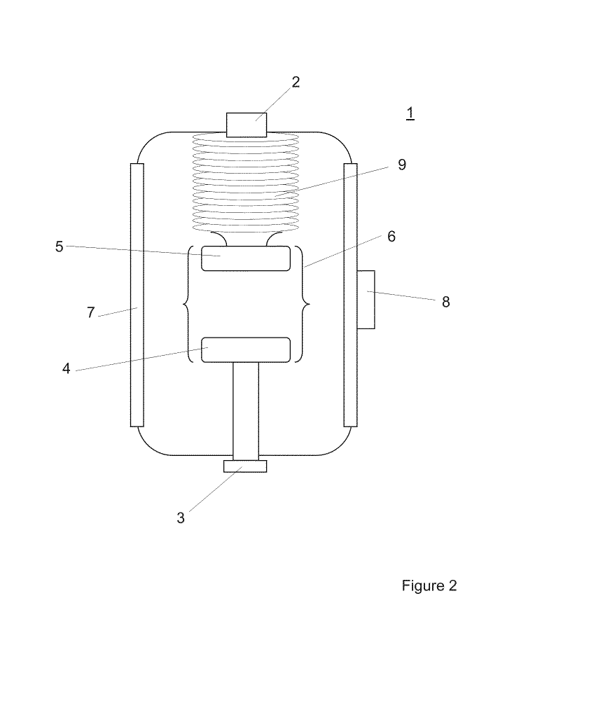

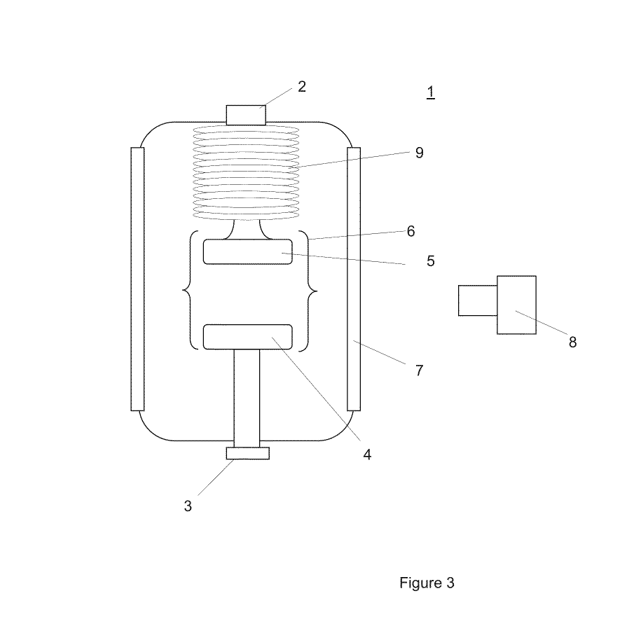

FIG. 2 shows a first placement of the x-ray source. The best geometric placement for that is in line with the two contacts. The upper contact 5 is the moving contact, which is fixed on a bellow and electrically connected to the upper connection point 2. FIG. 3 shows a second placement of the x-ray source.

The lower fixed contact 4 is connected with the connection point 3. Like it already said, in this alternative, the x-ray source is fixed externally to the vacuum interrupter 1.

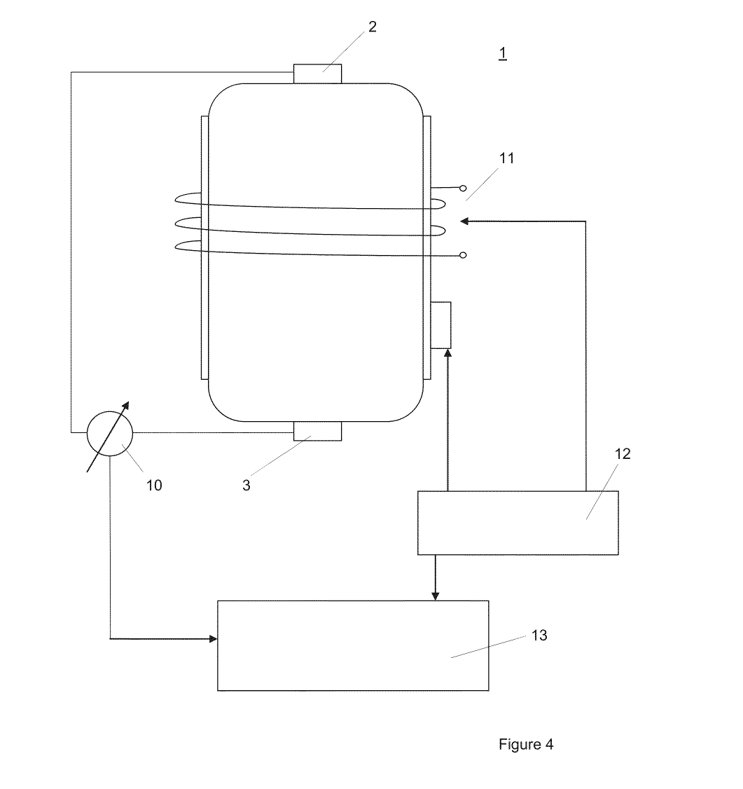

Additionally to both alternatives a magnetic field source must be arranged close to the vacuum interrupter, like shown in FIG. 4.

So if the contacts are opened, a coincidence unit 12 generates a magnetic field by at least a current pulse, which is generated coincidently to the x-ray source generation signal.

The resulting current to that coincident impact is measured between the connection points 2 and 3 of the opened contacts 4 and 5. In a pressure determination unit 13, the concerning actual rest gas pressure inside the vacuum interrupter can be determined.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### POSITION NUMBERS

1 Vacuum interrupter
2 External connection point to moving contact
3 External connection point to fixed contact
4 Fixed contact
5 Moving contact
6 Shielding
7 Ceramic body
8 X-ray source
9 Bellow
10 Current measuring device
11 Magnetic field generator
12 Coincidence unit
14 Pressure determination

1. A method for determining a pressure inside of a vacuum interrupter for medium or high voltage use, the vacuum interrupter including a fixed contact piece and movable contact piece arranged inside a technical vacuum of the vacuum interrupter, the contact pieces being electrically connected to external electrical fixation points, the method comprising:
connecting the external electrical fixation points with an external electrical energy source, in which disconnected or closed position of, the vacuum interrupter will be used;
applying a magnetic field element or magnetic field generating unit to thereby generate an approximate axial magnetic field, so that an effect of a cold cathode vacuum gauge will be used;
initiating a current inside the vacuum interrupter by seed electrons generated from x-ray induced ionization of a material on a surface inside the vacuum interrupter, causing a resulting current of electrons and ions; and
measuring the resulting current with high resolution, to determine by this current a residual gas pressure inside the vacuum interrupter.

2. The method of claim 1, further comprising:
applying an external x-ray source near to the vacuum interrupter, with the x-ray radiation directed towards the two electrodes.

3. A vacuum interrupter for medium or high voltage use, the vacuum interrupter comprising:
a fixed contact piece; and
a movable contact piece,
wherein the contact pieces are arranged inside a technical vacuum of the vacuum interrupter,
wherein the contact pieces are electrically connected to external electrical fixation points,
wherein the vacuum interrupter is configured to be applied with an internal or an external x-ray source,
wherein the vacuum interrupter is additionally configured to be applied with an internal or external magnetic field element or magnetic field generating unit, and
wherein the vacuum interrupter is additionally configured such that a discharge current measured by current measuring unit during x-ray and/or magnetic field exposition is used for determining a rest gas pressure in the vacuum interrupter in a calculation unit.

4. The interrupter of claim 3, further comprising:
a coincidence unit, configured to generate signals for the X-ray source and/or the magnetic field generating unit and/or a high voltage source in a timely coincidental way.

5. The interrupter of claim 4, wherein the coincidence unit is configured to generate signals for the X-ray source.

6. The interrupter of claim 4, wherein the coincidence unit is configured to generate signals for the magnetic field generating unit.

7. The interrupter of claim 4, wherein the coincidence unit is configured to generate signals for the high voltage source.

8. The interrupter of claim 3, configured to be applied with the internal x-ray source.

9. The interrupter of claim 3, configured to be applied with the external x-ray source.

10. The interrupter of claim 3, configured to be applied with the internal magnetic field element.

11. The interrupter of claim 3, configured to be applied with the external magnetic field element.

12. The interrupter of claim 3, configured to be applied with the magnetic field generating unit.

13. The interrupter of claim 3, further comprising:
a determination unit, configured to determine a pressure out of the current signal between both electrical connections points of the vacuum interrupter.
